(19) United States
(12) Patent Application Publication
(10) Pub. No.: US 2014/0149493 A1
(43) Pub. Date: May 29, 2014

(54) METHOD FOR JOINT SERVICE PLACEMENT AND SERVICE ROUTING IN A DISTRIBUTED CLOUD

(71) Applicants: Utku Gunay ACER, Antwerp (BE); Ivica Rimac, Remseck (DE)

(72) Inventors: Utku Gunay ACER, Antwerp (BE); Ivica Rimac, Remseck (DE)

(21) Appl. No.: 13/688,508

(22) Filed: Nov. 29, 2012

(51) Int. Cl. H04L 29/06

(52) U.S. Cl. CPC H04L 67/42
USPC 709/203

(57) ABSTRACT

Various exemplary embodiments relate to a method for distributing an application in a distributed cloud computing system including a plurality of clients with demand and a plurality of data centers, including: determining a list of candidate clients for each of the plurality of data centers; determining a set of data centers having capacity; determining a cost of providing service by each data center having capacity; and determining the data center having capacity with the lowest cost of providing service, wherein the determined data center is selected to provide service to the plurality of clients.

### TECHNICAL FIELD

Various exemplary embodiments disclosed herein relate generally to service placement in cloud computing.

### BACKGROUND

Large cloud service providers, such as Amazon EC2, Google, etc., deploy a small number of very large-scale data centers that centralize computational, bandwidth and memory resources into large aggregates that provide efficiencies of cost and operation. A large-scale data center typically hosts multiple tenants, each of which has its own enterprise-scale network instantiated inside the data center. In this multi-tenant case, servers (e.g., virtual machines) are exclusively reserved for each tenant, with guarantees of data isolation that prevents data from one tenant being accessible to another tenant.

An alternative to this architecture consists of a large number of smaller, geographically distributed data centers. This model may be called a distributed cloud. This model is particularly attractive to network service providers as they already have the facilities in place (e.g., central offices, regional offices) that are connected through a high-speed wide area network. One striking advantage of the distributed cloud is the proximity of the computation to the end-user. By placing computation close to the user and directing user requests to the nearby data centers, the latency between the user and data center may be reduced which may in turn improve the user experience.

The distributed cloud architecture introduces challenges in terms of management of the computing and network resources. The pricing of the computing resources in different data centers might be different as the regulations in the geographical location and the cost of the utilities, electricity etc., may be different. Besides, unlike a huge data center, a single small data center cannot provide a virtually infinite amount of resources. Two key tasks performed by the cloud management is the placement of allocated virtual machines (VM) into physical machines hosted in the data centers and the routing of packets through the VMs that provide the services of the application. As used herein, the term “routing” means selecting instances of each service for a particular user rather than finding the paths between two physical or virtual servers.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method for distributing an application in a distributed cloud computing system including a plurality of clients with demand and a plurality of data centers, including: determining a list of candidate clients for each of the plurality of data centers; determining a set of data centers having capacity; determining a cost of providing service by each data center having capacity; and determining the data center having capacity with the lowest cost of providing service, wherein the determined data center is selected to provide service to the plurality of clients.

Various exemplary embodiments relate to a cloud controller for distributing an application in a distributed cloud computing system including a plurality of clients with demand and a plurality of data centers, the cloud controller including: a data storage; a processor in communication with the data storage, the processor being configured to: determining a list of candidate clients for each of the plurality of data centers; determining a set of data centers having capacity; determining a cost of providing service by each data center having capacity; and determining the data center having capacity with the lowest cost of providing service, wherein the determined data center is selected to provide service to the plurality of clients.

### BRIEF DESCRIPTION OF THE DRAWINGS

In order to better understand various exemplary embodiments, reference is made to the accompanying drawings, wherein:

FIG. 1 illustrates an exemplary cloud architecture 100 for providing cloud resources;

FIG. 2 illustrates an exemplary cloud controller;

FIG. 3 illustrates a model of the cloud application by a linear task chain;

FIGS. 4, 5, and 6 illustrate pseudo code for implementing a greedy algorithm to provide service placement and service routing;

FIGS. 7 and 8 illustrate how the performance changes with respect to the number of clients with aggregated end user demand; and

FIGS. 9 and 10 illustrate the performance of the simulation at the data centers in the cloud while keeping the number of clients fixed.

To facilitate understanding, identical reference numerals have been used to designate elements having substantially the same or similar structure or substantially the same or similar function.

### DETAILED DESCRIPTION

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments.

Referring now to the drawings, in which like numerals refer to like components or steps, there are disclosed broad aspects of various exemplary embodiments.

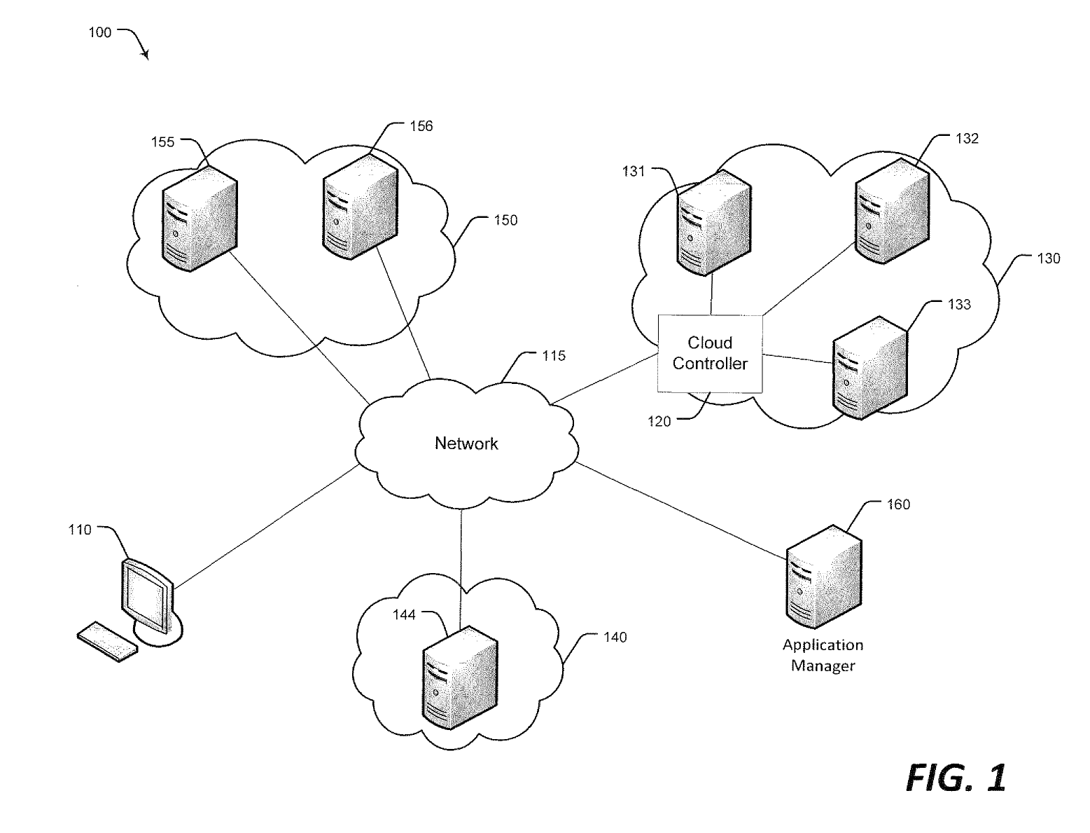

FIG. 1 illustrates an exemplary cloud architecture 100 for providing cloud resources. The cloud architecture 100 may implement a networked cloud architecture and may include a client device 110, a network 115, a cloud controller 120, data centers 130, 140, 150, and an application manager 160.

The client device 110 may be any device configured to utilize one or more cloud resources. In various embodiments, the client device 110 may be a desktop computer, laptop, tablet, mobile device, server, or blade. The client device 110 may communicate with other devices, such as the cloud controller 120, via the network 115. The client device 110 may transmit a request for one or more cloud resources to the cloud controller 120. For example, the client device 110 may request the use of one or more virtual machines (VMs), groups of VMs, storage devices, or memory. Additional types of cloud resources will be apparent. The client device 110 may represent a device of a user that requests the deployment of a distributed cloud application from the cloud controller 120 or the client device 110 may represent a customer of such a user that requests the use of one or more components of such a distributed cloud application by directly communicating with such resources 131, 132, 133, 144, 155, 166. It will be apparent that multiple additional client devices (not shown) may be in communication with the network 115 and such additional client devices may belong to additional users and customers.

The network 115 may be any network of devices or transmission media capable of enabling communication between the various devices of the exemplary cloud architecture 100. For example, the network 115 may include numerous devices configured to exchange and route data packets toward various destinations. In various embodiments, the network 115 may include the Internet or one or more carrier networks.

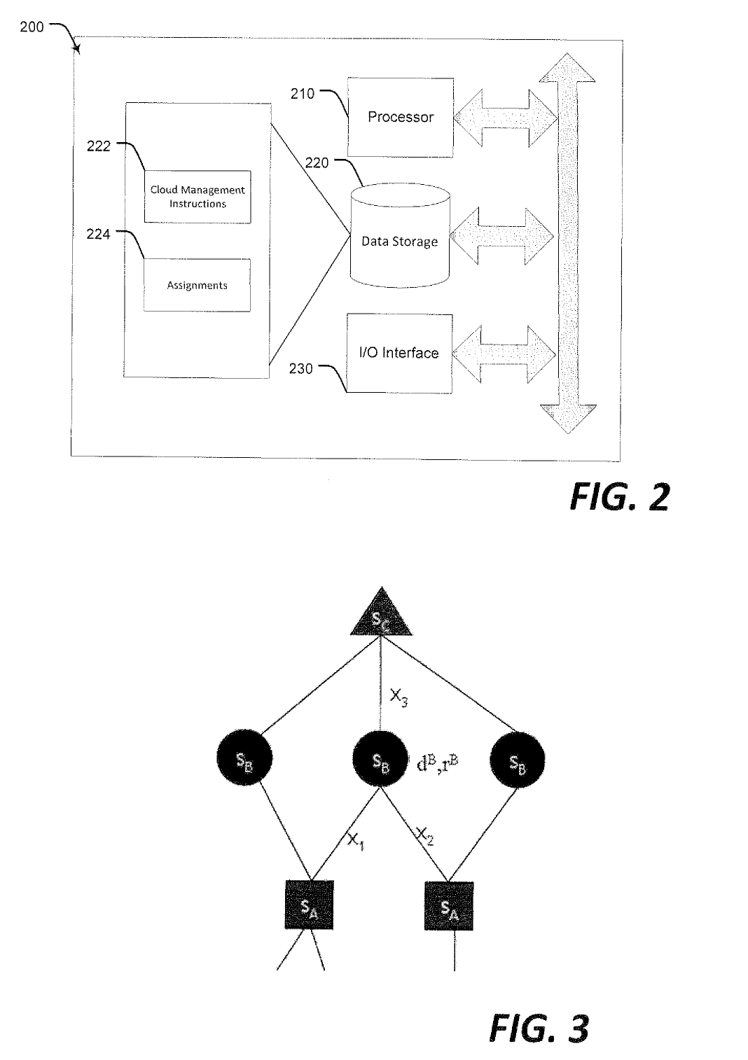

The cloud controller 120 may be a device configured to control the operations of a networked cloud. The cloud controller 120 may include various hardware such as a storage device, memory, or one or more processors, as will be described in greater detail below with respect to FIG. 2. As used herein, the term “processor” will be understood to encompass a variety of devices such as microprocessors, field-programmable gate arrays (FPGAs), application-specific integrated circuits (ASICs), and other similar processing devices. In various embodiments, the cloud controller 120 may include, for example, a server, a blade, a personal computer, a laptop, a tablet, or a mobile device. In some such embodiments, the cloud controller 120 may be a virtual machine that utilizes cloud resources such as, for example, the hardware resources provided by cloud devices 131, 132, 133. The cloud controller 120 may reside at a data center, such as data center 130, or may reside elsewhere. The cloud controller 120 may perform various cloud management functions, including management of cloud resource allocation. As such, the cloud controller 120 may receive requests for the establishment of cloud applications from client devices such as the client device 110. Upon receiving such requests, the cloud controller 120 may allocate requested resources from one or more of the cloud devices 131, 132, 133, 144, 155, 156, for use by client devices. In various embodiments, the exemplary cloud architecture 100 may include multiple cloud controllers (not shown). Various techniques for coordinating the operation of multiple cloud controllers will be apparent.

The data centers 130, 140, 150 may each be locations supporting one or more devices that provide cloud resources. For example, data center 130 may host cloud devices 131, 132, 133; data center 140 may host cloud device 144; and data center 150 may host cloud devices 155, 156. The data centers 130, 140, 150 may be geographically distributed or may be situated at different network distances from the client device 110. For example, the client device 110 may be located in Washington, D.C., data center 140 may be located in Chicago, data center 150 may be located in Paris, and data center 130 may be located in Tokyo. According to this example, the client device 110 may experience less network latency when communicating with data center 140 than when communicating with data center 130. It will be apparent that the cloud architecture 100 may include numerous additional data centers (not shown) and that each data center may include any number of cloud devices.

Each of cloud devices 131, 132, 133, 144, 155, 156 may be a device configured to provide cloud resources for use by client devices. In various embodiments, each of the cloud devices 131, 132, 133, 144, 155, 156 may be a desktop computer, laptop, tablet, mobile device, server, or blade. As such, the cloud devices 131, 132, 133, 144, 155, 156 may include various hardware such as, for example, storage devices, memory, or one or more processors. The cloud devices 131, 132, 133, 144, 155, 156 may be configured to provide processing, storage, memory, VMs, or groups of VMs for use by client devices such as the client device 110.

In various embodiments, such as the embodiment illustrated in FIG. 1, the cloud controller 120 may interface with an application manager 160 to deploy and subsequently scale a cloud application with demand. The application manager 160 may be, for example, a desktop computer, laptop, tablet, mobile device, server, or blade and may include a virtual machine.

FIG. 2 illustrates an exemplary cloud controller 200. The exemplary cloud controller 200 may correspond to the cloud controller 120 of the exemplary cloud architecture 100. The cloud controller 200 may include a processor 210, a data storage 220, and an input/output (I/O) interface 230.

The processor 210 may control the operation of the cloud controller 200 and cooperate with the data storage 220 and the I/O interface 230, via a system bus. As used herein, the term “processor” will be understood to encompass a variety of devices such as microprocessors, field-programmable gate arrays (FPGAs), application-specific integrated circuits (ASICs), and other similar processing devices.

The data storage 220 may store program data such as various programs useful in managing resources in a cloud. For example, the data storage 220 may store cloud management instructions 222 for performing one or more methods such as, for example, those described in below. The cloud management instructions 222 may include further instructions or methods useful in cooperating with one or more application managers and coordinating the operations of various data centers, hypervisors, or virtual machines.

The data storage may also store records of assignments 224. For example, for each component that the cloud controller 200 establishes and assigns to a distributed application, the cloud controller may store a record among the assignments 224. In this manner, the cloud controller 200 may keep track of the resources used to implement a distributed application.

The I/O interface 230 may cooperate with the processor 210 to support communications over one or more communication channels. For example, the I/O interface 230 may include a user interface, such as a keyboard and monitor, and/or a network interface, such as one or more Ethernet ports.

In some embodiments, the processor 210 may include resources such as processors/CPU cores, the I/O interface 230 may include any suitable network interfaces, or the data storage 220 may include memory or storage devices. Moreover the cloud controller 200 may be any suitable physical hardware configuration such as: one or more server(s), blades consisting of components such as processor, memory, network interfaces or storage devices. In some of these embodiments, the cloud controller 200 may include cloud network resources that are remote from each other.

In some embodiments, the cloud controller 200 may include one or more virtual machines. In some of these embodiments, a virtual machine may include components from different physical machines or be geographically dispersed. For example, the data storage 220 and the processor 210 may reside in two different physical machines.

In some embodiments, the cloud controller 200 may be a general purpose computer programmed to perform the methods described below.

When processor-executable programs are implemented on a processor 210, the program code segments combine with the processor to provide a unique device that operates analogously to specific logic circuits.

Although depicted and described herein with respect to embodiments in which, for example, programs and logic are stored within the data storage and the memory is communicatively connected to the processor, it should be appreciated that such information may be stored in any other suitable manner (e.g., using any suitable number of memories, storages or databases); using any suitable arrangement of memories, storages or databases communicatively connected to any suitable arrangement of devices; storing information in any suitable combination of memory(s), storage(s) or internal or external database(s); or using any suitable number of accessible external memories, storages or databases. As such, the term data storage referred to herein is meant to encompass all suitable combinations of memory(s), storage(s), and database(s).

When implementing a distributed application using the services of a distributed cloud computing architecture, two problems must be considered. The first is service placement. Given that multiple instances of each service are needed to ensure scalability, how should the services be placed such that the overall network distance traveled by service flows are minimized. The second is service routing. With a set of service instances for each service in the distributed cloud computing architecture, what particular instances of the services should be selected so that the overall network distance traveled by service flows are minimized. Network aware mechanisms, such as those described in the algorithms below, may be used that determine, for each service of the distributed application, how many virtual machines should be allocated in every data center and the amount of service requests are distributed to them. Such mechanisms may be implemented in the cloud controller 120 or 200.

In the literature, both of these problems have been studied; however, most of the solutions to one problem assumes the knowledge about the other. Most placement algorithms assume that they are supplied with the traffic pattern between the individual VMs, and the service routing models assume the knowledge of the location of the VMs. The embodiments described below include a joint solution to these problems within the context of distributed cloud computing architecture without using knowledge about the number of VMs to be deployed and the traffic between them. Instead, in the described embodiments VMs are placed and routing decisions are concurrently made.

A cloud application may be modeled as a linear task chain. The application may be composed of independent components that process the service request in sequence. One example may be a web application that includes a web server, application server and data base. For such an application, the placement and routing problem may be modeled as a mixed integer linear program, which is hard to solve when the problem space is large. Due to its high computational complexity, a greedy algorithm may be used as described in the embodiments below. This greedy algorithm may be efficient with respect to application speed and may perform relatively close to the optimum performance. This greedy algorithm may outperform a placement mechanism that randomly places the VMs and makes the routing decisions for each VM based on its proximity to VMs for the next service.

Service placement may map VMs hosting services onto physical machines in one or more data centers. It may be a useful way of improving operational efficiency. A service placement algorithm may collocate several VMs onto as few servers as possible to increase the number of unneeded servers that can be shut-down to reduce the operating cost of the cloud. Alternately, the service placement algorithm may spread VMs as evenly as possible, to maximize headroom for new VMs or to avoid bandwidth bottlenecks. The service placement algorithm may even maximize the performance of individual services by co-locating their VMs or considering policy requests from customers.

In “Optimizing a virtualized data center,” SIGCOMM Comput. Commun. Rev., vol. 41, no. 4, pp. 478-479, August 2011, by Erickson, B. Heller, S. Yang, J. Chu, J. Ellithorpe, S. Whyte, S. Stuart, N. McKeown, G. Parulkar, and M. Rosenblum, the authors pose the following question: can a virtualized data center be more efficient if the operator has visibility into network traffic and control over packet routing? The authors create algorithms based on mixed integer programming to optimize for performance in terms of spreading workload and network traffic, or energy by collapsing the workload onto as few machines and network links as possible.

Placement of a set of VMs with the given traffic pattern for every node pair on a data center is studied in “Improving the scalability of data center networks with traffic-aware virtual machine placement,” INFOCOM, 2010 Proceedings IEEE, pp. 1-9, 2010, by X. Meng, V. Pappas, and L. Zhang. The optimal solution to determine the physical machines for every VM is shown to be NP-Hard. The authors propose a heuristic that places VM pairs with heavy traffic to physical hosts with low-cost connections. A similar approach is taken in “Network aware resource allocation in distributed clouds,” in INFOCOM, 2012 Proceedings IEEE, 2012, pp. 963-971 by M. Alicherry and T. Lakshman, but in the context of a distributed cloud. The algorithms minimize the maximum distance between the VMs both in a distributed cloud and within a data center, which may or may not minimize the cost of traffic in the inter-connected network. In both papers, the algorithms do not address service routing.

The placement of the interacting components of a distributed application is considered in “Optimal resource-aware deployment planning for component-based distributed applications,” in Proceedings of the 13th IEEE International Symposium on High Performance Distributed Computing IEEE Computer Society, 2004, pp. 150-159, by T. Kichkaylo and V. Karamcheti. In this article, placement is modeled by an artificial intelligence problem what takes the requirements of the components in terms of CPU and storage they use and the connection between them, such as link bandwidth, into the consideration. Unlike the embodiments described below, each service is provided by a single replica, and hence, no service routing is necessary in this setting. A component placement strategy that seeks to achieve application-level latency requirements for distributed applications is presented in “Placement in clouds for application-level latency requirements,” 2012 IEEE Fifth International Conference on Cloud Computing, pp. 327-335, 2012 by F. Chang, R. Viswanathan, and T. L. Wood. These authors propose an exhaustive search mechanism over the universe of all possible assignments of the components to the possible locations, which has a exponential worst-case running time. Hence, they provide a heuristic that partitions the problem into smaller pieces and solves each problem independently. The embodiments described below differ in that the setting assumes that each virtual server has a limit in the amount of demand it can address.

Hedera reroutes long-lived flows to achieve high bisection bandwidth in a data center in “Hedera: Dynamic flow scheduling for data center networks,” in In Proc. of Networked Systems Design and Implementation (NSDI) Symposium, 2010 by M. Al-fares, S. Radhakrishnan, B. Raghavan, N. Huang, and A. Vandat. Instead of bisection bandwidth, the embodiments described below aim to minimize the cumulative network distance traversed in the entire cloud inter-connected network, which may lead to a better predictor of network efficiency.

DONAR on the other hand addresses the server selection problem in “Donar: decentralized server selection for cloud services” in SIGCOMM, 2010, pp. 231-242 by P. Wendell, J. W. Jiang, M. J. Freedman, and J. Rexford. This article takes the network distance as well as balanced load into consideration when clients pick what servers they will use. Unlike the embodiments described below, DONAR works with already placed servers. Besides, the cloud only hosts one particular type of server instead of a distributed application composed of multiple components.

Algorithms that jointly makes placement and service selection decisions are presented in “Network-aware service placement and selection algorithms on large-scale overlay networks,” Computer Communications, vol. 34, no. 15, pp. 1777-1787, 2011 by J. Famaey, T. Wauters, F. D. Turck, B. Dhoedt, and P. Demeester. The physical servers are assumed to form an overlay network. The algorithms try to maximize the amount of satisfied demand based on some service requirements and minimize the number of used physical servers in order to save energy. Even though multiple service types are considered, each service is independent and does not interact with the others. Because the decision to place a service on a particular physical machine is binary, the problem translates into an integer program and is NP-Hard.

An embodiment will now be described that provides both service placement and service routing. The distributed applications may be modeled by linear task chains. Let the ordered list S=s₁, s₂, . . . , s_{N} denote the application. A user request related to the application may go through each of the services s₁, s₂, . . . , s_{N} in sequence where N is the number of the distributed components in the application. This model may provide the sense that the virtual machines that provide the service sᵢ₋₁ and sᵢ are clients and the servers for the ith service, respectively.

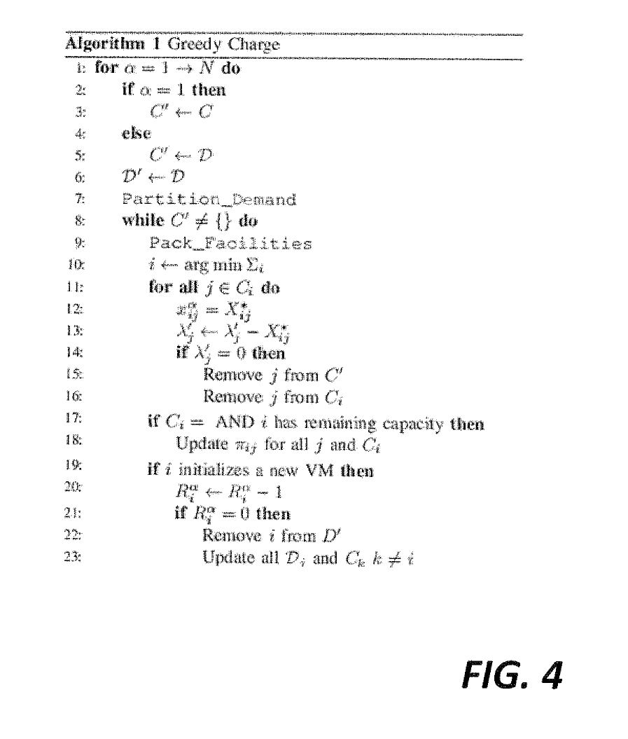

FIG. 3 illustrates a model of the cloud application by a linear task chain. The model assumes that there is a linearity between the amount of demand each VM requires based on its type. FIG. 3 illustrates an example with three components. For clarity and to prevent confusion with respect to notations used below, letters instead of numbers are used to distinguish components in this example. The application may include three components such as a web service. s_{A} machines may be the web servers, s_{B} machines may be application servers, and s_{C} may be the data base for the application. FIG. 3 assumes that there are two instances of s_{A}, three instances of S_{B}, and a single instance of s_{C}. Consider the second instance of s_{B} (the one in the middle) that serves both instances of s_{A} and the amount of demand it satisfies from s_{A} machines corresponds to x₁+x₂. This amount cannot exceed the capacity of the VM which is given by d^{B}. On the other hand, the service it provides to s_{A} machines may translate into demand from s_{C} machines. The amount of such demand may be given by r^{B}(x₁+x₂)=x₃, where r specifies a rate value that reflects a machines capability to meet demand, for example processing throughput of a machine. These assumptions stem from each VM specifying a different set of requirements and that cloud providers typically offer only a limited number VM profiles. Because aggregated client demands are considered rather than individual end-user demand, the demand from a client may be served by multiple data centers.

Let cᵢⱼ denote the cost of transporting unit demand between nodes i and j. Here, at least one of the nodes may be a data center. The second node is either a data center or the aggregated client demand point. Let λⱼ^{α} denote the aggregated demand of s_{α-1} machines in j (j is a end-user only if α=1) from s_{α} machines in all the data centers, where a indicated type of machine/service, i.e., A, B, or C in FIG. 3. xᵢⱼ is the amount of service request from data center i that node j holds. yᵢ^{α} denotes the number of a type virtual machines on data center i, and fᵢ^{α} denotes the cost of initializing one s_{α} type VM: on that data center. Rᵢ^{α} is the maximum number of a type machines data center i can host.

The joint placement-routing problem may be formulated as:

minΣ_{i,j,α}xᵢⱼ^{α}cᵢⱼ+Σ_{i,α}yᵢ^{α}fᵢ^{α} (1)

such that

$$\begin{matrix}{\sum }_{i} {x}_{ij}^{a} \geq {λ}_{j}^{a} {∀}_{j , a} & ( 2 ) \\ {\sum }_{j} {x}_{ij}^{a} - {y}_{i}^{a} {d}^{a} \leq 0 {∀}_{i , a} & ( 3 ) \\ {y}_{i}^{a} \leq {R}_{i}^{a} {∀}_{i , a} & ( 4 ) \\ {x}_{ij}^{a} , {y}_{i}^{a} \geq 0. {∀}_{i , j , a} & ( 5 )\end{matrix}$$

The first summation in expression (1) determines the communication cost of having node j satisfy demand of node i. The second summation in expression (1) determines the cost of adding additional resources to satisfy demand. In this definition, constraint (2) ensures that all demand is satisfied, i.e., the sum of all of the service provided by xᵢ for i of type α is greater than the aggregated demand λⱼ^{α}. Relationship (3) provides that every data center has enough resources to respond all the demand assigned to it while relationship (4) provides that the amount of resources should be below the capacity of the data center. This relationship may also be used to balance the load on the data centers as well. Note that, Rᵢ^{α} may be further extended to explicitly state how much demand the data centers may satisfy due to limitations other than capacity such as load balancing requirements, reliability, etc. Here, it may be assumed that each VM type has a separate profile yet it may be straightforward to extend the formulation to the case that two components might use the same profile. It is possible to place replicas of several components in one data center, so xᵢᵢ^{α} is likely above 0 for α values beyond 1. The final relationship (5) provides that all the variables are positive.

Given the application specific r^{α} values, the demand λⱼ^{α} may be calculated as:

$${λ}_{j}^{a} = {\sum }_{k} {x}_{jk}^{a - 1} {r}^{a} . \qquad ( 6 )$$

That is, the amount of demand that data center i has from s_{α} machines depends on the amount of demand it satisfies by its s_{α-1} machines. On the lowest level, λⱼ⁰ are already given.

Because the number of VMs in the optimization problem may only be integers, optimizing equation (1) is a NP-Hard mixed linear non-binary integer problem. If the cloud operator and the application allow customized sized VMs in terms of used resources, and the y values are allowed to be continuous values, the problem then turns into a linear program which may be solved efficiently by optimization tools. If this is not the case, the exact solution to the problem cannot be found efficiently if the size of the problem is large, such as is the case when provisioning cloud applications in a cloud infrastructure. Due to such a high complexity, a greedy algorithm may be used. A greedy algorithm is an algorithm that follows the problem solving heuristic of making the locally optimal choice at each stage with the hope of finding a global optimum. In many problems, a greedy strategy does not in general produce an optimal solution, but nonetheless a greedy heuristic may yield locally optimal solutions that approximate a global optimal solution in a reasonable time. Below a greedy algorithm is described to optimize expression (1).

Table I below summarizes the notation used in describing the greedy algorithm. Let D be the set of data centers on which VMs may be instantiated, and let C be the set of end users with aggregated demand. Note that for α>1, the data centers become clients with aggregated demand. For each j, the algorithm may calculate the charge of using every data center i in terms of the cost of the connection between them as well as the amount of the available resources.

TABLE I
NOTATION SUMMARY

| | |
|---|---|
| C′ | set of clients with residual demand |
| [symbol] ′ | set of data centers with remaining capacity |
| λⱼ′ | remaining demand for client j |
| [symbol] ⱼ | list of candidate data centers for client j ordered by ascending π |
| Cᵢ | list of candidate clients for data center i ordered by ascending π |
| Xᵢⱼ* | demand from client j that should be satisfied by data center i |
| Σᵢ | aggregated charge of data center i |

An overview of the greedy algorithm used to optimize the placement of the application components is first given followed by a more detailed description of the greedy algorithm. The greedy algorithm progresses sequentially over the component types in order to find an optimal choice for each component type. The greedy algorithm may first place the instances of s₁ on the data centers and determine the traffic from the clients to data centers. To do that, the greedy algorithm looks at the cost of reserving resources as well as the cost of connecting to them. It also considers that instances of other components should be placed close to the instance they interact with. For each client, the greedy algorithm may sort the data center options for the potential charge by assigning the demand of the client to the data center. Then, the greedy algorithm may look at each data center for the potential aggregate charge for satisfying the demand from the clients. At each step, the data center with the minimum charge may be selected. The greedy algorithm may repeat this procedure until all the demand is met. Alternatively, the algorithm may repeat until at least a portion of the demand is met.

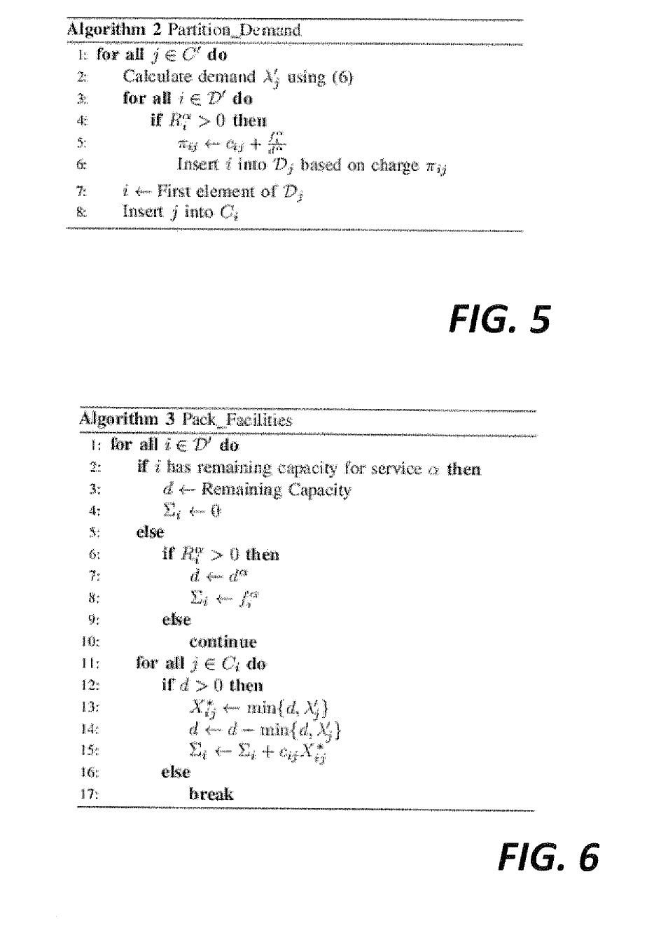

FIGS. 4, 5, and 6 illustrate pseudo code for implementing a greedy algorithm to provide service placement and service routing and to provide a solution to expression (1). In FIG. 4, the greedy charge algorithm may loop through each service type from 1 to N. In steps 2 through 5 the set of clients with residual demand C may be initialized. If α is 1, i.e., the first service type, then C may be set to the list of all candidate clients of type 1. Alternatively, C may be set to a portion of the list of all candidate clients of type 1. If α is other then 1, then C may be set to the list of all candidate data centers for data centers of type α. Alternatively, C may be set to the list of a portion of all candidate data centers for data centers of type α. In step 6, the set of data centers with remaining capacity D′ may be initialized. At step 7 the Partition_Demand algorithm may be performed.

FIG. 5 illustrates pseudo code for implementing a Partition_Demand algorithm. The Partition_Demand algorithm may loop through all of the set of clients C. Alternatively, Partition_Demand algorithm may loop through a portion of all of the set of clients C. The set C is a list of indexes for each data center with residual demand. At step 2 of the Partition_Demand algorithm, the remaining demand for client j λ′ⱼ may be calculated using equation (6). At step 3, the Partition_Demand algorithm may loop through all of the data centers D′ with remaining capacity. Alternatively, the Partition_Demand algorithm may loop through a portion of all of the data centers D′ with remaining capacity. At step 4 the Partition_Demand algorithm determines if the ith data center has capacity. If so, steps 5 and 6 of the Partition_Demand algorithm may calculate the cost πᵢⱼ and inserts i into the set Dⱼ in ascending order based upon πᵢⱼ The cost πᵢⱼ may be based upon the cost of transmitted demand between i and j and the cost of initializing an additional VM. When the Partion_Demand algorithm has looped through the data centers D′, the set Dⱼ is an ordered list of candidate data centers starting with the lowest cost candidate data center. At step 7, the Partition_Demand algorithm then may set i equal to first element of Dⱼ which identifies the lowest cost candidate data center. At step 8, the Partition_Demand algorithm then may insert j into Cᵢ, with the elements of Cᵢ being ordered by increasing cost. Cᵢ thus may become a list of potential candidate clients for data center i listed in order of the cost of implementing the candidate clients on the data center i. The Partition_Demand algorithm then may end and may return back to the greedy charge algorithm.

At step 8, the greedy charge algorithm may loop until there are no remaining elements of C, i.e., until all or some specified portion of client demand has been satisfied. At step 9, the greedy algorithm may perform the Pack_Facilities algorithm.

FIG. 6 illustrates pseudo code for implementing a Pack_Facilities algorithm. At step 1, the Pack_Facilities algorithm may loop for all i in D′. Alternatively, the Pack_Facilities algorithm may loop for a portion of all i in D′. At step 2, the Pack_Facilities algorithm may determine if i has remaining capacity for service α. If so, at step 3 the capacity d may be set to the remaining capacity, and at step 4, the cost Σᵢ may be set to 0. If not, at step 6, the Pack_Facilities algorithm may determine if Rᵢ^{α} is greater than 0, i.e., is there remaining capacity of type α at data center i. If so, then at step 7 the capacity d may be set to d_{α}, and at step 8, the cost Σᵢ may be set to fᵢ^{α}. If not, the Pack_Facilities algorithm just continues at step 10. At step 11, the Pack_Facilities algorithm may loop for all j in Cᵢ. Alternatively, the Pack_Facilities algorithm may loop for a portion of all j in Cᵢ. At step 12, the Pack_Facilities algorithm may determine if the capacity d is greater than 0. If so, then at step 13 the Pack_Facilities algorithm may set Xᵢⱼ*, the demand from client j that should be satisfied by data center i, to the minimum of d and λ′ⱼ. Next at step 14 of the Pack_Facilities algorithm, the demand d may be updated by reducing d by min{d, λ′ⱼ}. At step 15, the Pack_Facilities algorithm may update the potential cost Σᵢ based upon cᵢⱼ and Xᵢⱼ*. At step 17, the Pack_Facilities algorithm may end if the capacity d is not greater than 0. Upon completion of the Pack_Facilities algorithm, the greedy charge algorithm may continue.

At step 10, the greedy charge algorithm may select the minimum potential cost by setting i to arg min Σᵢ. St step 11, the greedy charge algorithm my loop for all j in Cᵢ. At step 12, xᵢⱼ^{α} is set to Xᵢⱼ*. Alternatively, the greedy charge algorithm my loop for a portion of all j in Cᵢ. Next at step 13, the aggregated demand λ′ⱼ is updated by subtracting Xᵢⱼ*. At step 14, the greedy algorithm may determine if the aggregated demand λ′ⱼ is 0. If so, at step 15, j may be removed from C, and at step 16 j may be removed from Cᵢ. Then the loop for j in C, may end or may return to step 11.

At step 17, the greedy algorithm may determine if Cᵢ is empty and if i has any remaining capacity. If so, then at step 18, the greedy algorithm may update πᵢⱼ for all j and Cᵢ. Alternatively, the greedy algorithm may update πᵢⱼ for a portion all j and Cᵢ. Next, at step 19, the greedy algorithm may determine if i initializes a new VM. If so then Rᵢ^{α} may be decremented. At step 21, the greedy algorithm further may determine if Rᵢ^{α} is 0. If so, then i may be removed from D′ at step 22, and Dⱼ and Cₖ are updated where k≠i at step 23. At this point the greedy algorithm may loop back for the next α value.

Upon completion of the greedy algorithm, the demand created by the user requests may be satisfied by the various machines identified in the greedy algorithm to implement the specific services needed to satisfy the user requests.

A stimulation was developed to analyze the performance of the greedy algorithm described above. The simulation synthetically generates distributed cloud topologies in order to evaluate the greedy algorithm. In this setting, n_{S} data centers and n_{C} clients with aggregated end user demand are generated. Each node (data center or client point) is assigned with a location in [0,1]. In this scenario, the distance between two nodes is assigned as the cost of the connection between them. In the simulation a three layer application is used with components A, B and C in order, as a simulated application in the evaluation. The application profile is defined by the following r constants: r^{A}=1.0, r^{B}=0.5 and r^{C}=2.0. Profiles for the VMs profiling these services are defined by the following constants: d^{A}=100, d^{B}=1000 and d^{C}=5000.

The number of VMs for each profile that each data center can host as well as the price for the VMs in each data center is a random variable. The capacities of the data centers for each VM profile are drawn from the following distribution:

$${U}^{a} \frac{{n}_{C}}{{n}_{S}} U [ 2 , 8 ]$$

where U^{A}˜U[20,100], U^{B}˜U[6,10], and U^{C}˜U[1,3]. This selection ensures that there is enough capacity in the cloud to satisfy the demand from all the clients.

For each client j, the aggregated initial demand λⱼ⁰ is assumed to follow a uniform distribution in the range [1000,10000]. Finally, the price of each VM is also drawn from uniform probability distributions. We have fᵢ^{A}˜U[40,50], fᵢ^{B}˜U[200,220] and fᵢ^{C}˜U[250,300] for each data center i.

The results of the greedy algorithm are compared with that of the optimal solution calculated by a mixed linear integer program solver and a simple heuristic called Random. In this heuristic, VMs are instantiated in random data centers while there is still demand for service. Once a VM is generated, it finds the closest clients with remaining demand and serve them.

Two metrics are used to evaluate the performance of the greedy algorithm. First is the overall cost, i.e., the value of the objective function. The second metric is the running time. The results with respect to the number clients and the number of data centers is presented. The simulation for each scenario was repeated 5 times and every data point in the following plots yield an average of those 5 measurements.

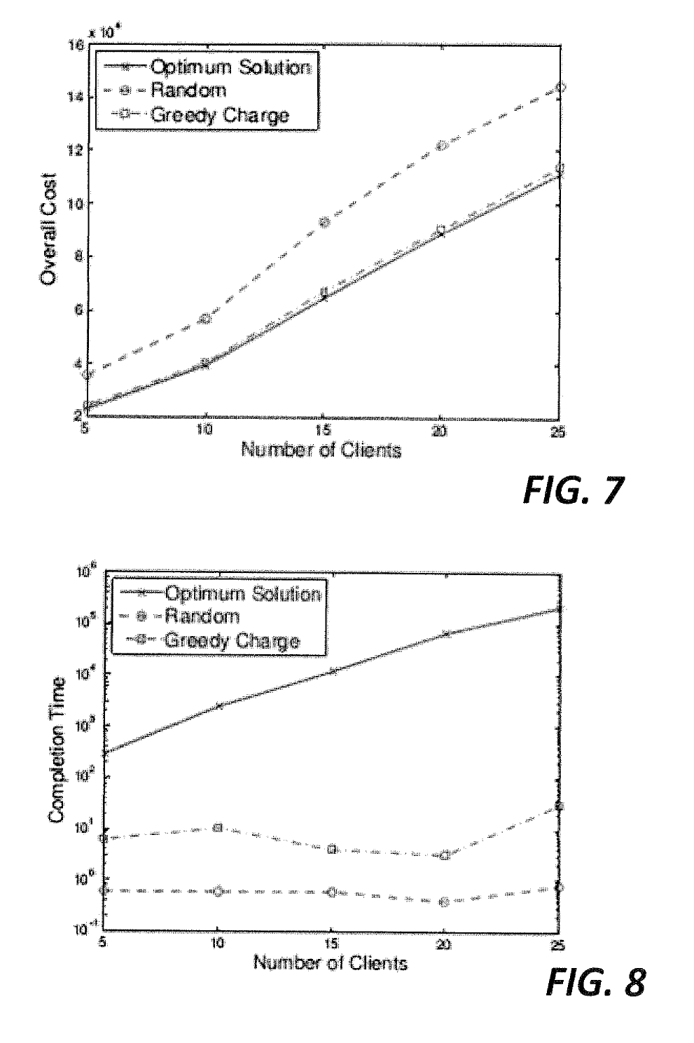

FIGS. 7 and 8 illustrate how the performance changes with respect to the number of clients with aggregated end user demand. In performing these simulations, the number data center n_{S} is set to 10. FIG. 7 shows that the overall cost increases in all three methods as the amount of load in the cloud increases. As the number of clients increases, the initial demand in the cloud also increases. Hence, more VMs are initialized in the data center and more traffic is carried on the inter-connect network. FIG. 7 shows the greedy algorithm performs close to the optimum solution; however, the completion time is much smaller in comparison as shown in FIG. 8. Random placement and routing on the other hand incurs higher cost than the greedy algorithm even if it completes in a shorter time. Note that even though Random has higher cost, its cost relative to the optimum solution decreases with the increasing number of the clients. This is because as the number of clients increases, the average distance between the clients and the data centers decreases. Hence, the cost of communication of decreases.

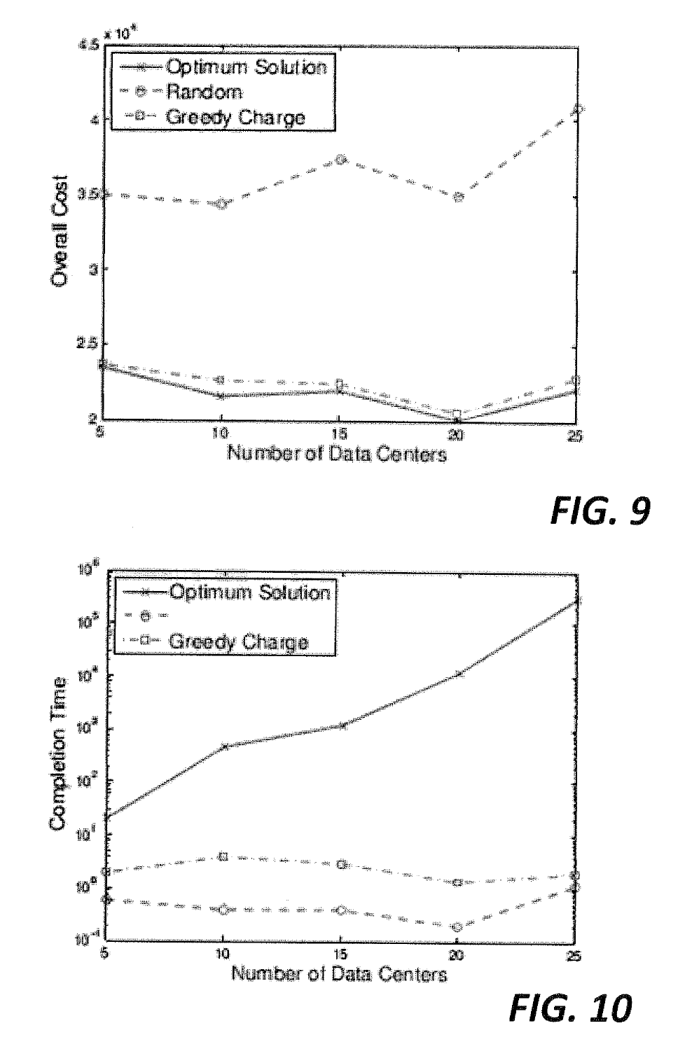

In FIGS. 9 and 10, the simulation looks at the number of data centers in the cloud while keeping the number of clients fixed at n_{C}=5. In this scenario, the sensitivity of the performance to the number of data centers when the demand from the end users remain the same is evaluated. FIG. 9 shows that the overall cost decreases for the optimum solution and the greedy algorithm as the number of data centers increases. This is because as the number of data centers increase, the clients are more likely to have close data centers with smaller communication cost. In the random solution on the other hand, approximately same number of VMs are generated in a larger number of data centers. The number of VMs remain the same because the initial demand is the same. Note that in this heuristic, placement is random and routing is greedy. Because of random placement, the clients may end up being served by VMs that are at further data centers even though there are closer data centers. The amount of the demand is roughly the same for Random and greedy algorithm because the initial demand is the same. However, it takes much longer to calculate the optimum solution as the number of variables and constraints quickly increase with the number of data centers as seen in FIG. 10.

As described above, an embodiment is described that addresses the joint problem of resource placement and service routing of distributed applications in a distributed cloud. The described embodiments may be implemented on a cloud controller. A simulation shows that the greedy algorithm described incurs a cost that is close to the optimal cost, whereas it takes a much shorter time to calculate than the optimum solution.

Alternatively, the described embodiments may be implemented in the distributed application itself. In such an embodiment, the distributed application would receive information relating to the cloud devices that are available as well as the costs associated with each of these cloud devices.

It should be apparent from the foregoing description that various exemplary embodiments of the invention may be implemented in hardware or firmware, such as for example, the application monitor, application performance analyzer, or the service level agreement analyzer. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a tangible and non-transitory machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method for distributing an application in a distributed cloud computing system including a plurality of clients with demand and a plurality of data centers, comprising:
determining a plurality of sets of candidate clients from the plurality of clients corresponding to a select plurality of data centers, the plurality of data centers comprising the select plurality of data centers;
determining a cost of providing service and a capacity capability for each of at least a portion of the select plurality of data centers; and
selecting a data center from the select plurality of datacenters to provide service to the plurality of clients based on the determined costs of providing service and the capacity capabilities.

2. The method of claim 1, further comprising updating the demand of the plurality of clients based upon the demand satisfied by the selected data center.

3. The method of claim 2, further comprising:
determining that the updated demand of a first client is 0;
removing the first client from a set of clients with demand; and
removing the first client from the plurality of sets of candidate clients.

4. The method of claim 1, further comprising:
determining that the selected data center initializes a new virtual machine; and
reducing a number of virtual machines available at the selected data center.

5. The method of claim 4, further comprising:
determining that the number of virtual machines available at the selected data center is 0; and
removing the selected data center from a set of data centers with available capacity.

6. The method of claim 5, further comprising:
determining a list of candidate data centers for each of at least of portion of the plurality of clients; and
removing the selected data center from each set of candidate data centers.

7. The method of claim 1, wherein determining a plurality of sets of candidate clients further comprises: calculating the remaining demand for at least one of the candidate clients.

8. The method of claim 7, wherein determining a plurality of sets of candidate clients further comprises:
calculating the cost of each of at least a portion of data centers providing capacity to a first candidate client;
selecting the data center with the lowest calculated cost; and
placing the selected data center in a set of candidate data centers for the first candidate client.

9. The method of claim 1, wherein determining a cost of providing service and a capacity capability for each of at least a portion of the select plurality of data centers further comprises:
initializing the cost of providing service for each of at least a portion of the select data centers;
determining the demand available at each of at least a portion of the select data centers for a first client; and
calculating the cost of providing service by each of at least a portion of the select data centers based upon the determined available demand at each of at least a portion of the select data centers and a cost of transporting demand between the data centers and the first client.

10. The method of claim 9, wherein initializing the cost of providing service for each of at least a portion of the select data centers further comprises:
determining that a first data center has remaining capacity and setting a first capacity to the remaining capacity; and
setting a cost of providing service by the first data center to 0.

11. The method of claim 9, wherein initializing the cost of providing service for each of at least a portion of the select data centers further comprises:
determining that a first data center has no remaining capacity and setting a first capacity to a capacity of an additional virtual machine; and
setting a cost of providing service by the first data center to the cost of an additional virtual machine.

12. The method of claim 9, wherein determining the demand available at each of at least a portion of the select data centers for a first client further comprises:
initializing a first capacity for a first data center; and
determining the demand available at the first data center as the minimum of the first capacity and remaining demand for the first client.

13. The method of claim 1, wherein the plurality of data centers becomes a second plurality of clients with demand and second plurality of data centers that satisfies the demand of the second plurality of clients further comprising:
determining a plurality of sets of candidate second clients from the plurality of second clients corresponding to a select plurality of second data centers, the plurality of second data centers comprising the select plurality of second data centers;
determining a cost of providing service and a capacity capability for each of at least a portion of the select plurality of second data centers; and
selecting a second data center from the select plurality of second datacenters to provide service to the plurality of second clients based on the determined costs of providing service and the capacity capabilities.

14. A non-transitory program storage device readable by a machine, embodying a program of instructions executable by the machine to perform method steps of claim 1.

15. A cloud controller for distributing an application in a distributed cloud computing system including a plurality of clients with demand and a plurality of data centers, the cloud controller comprising:
a data storage;
a processor in communication with the data storage, the processor being configured to:
determine a plurality of sets of candidate clients from the plurality of clients corresponding to a select plurality of data centers, the plurality of data centers comprising the select plurality of data centers;
determine a cost of providing service and a capacity capability for each of at least a portion of the select plurality of data centers; and
select a data center from the select plurality of datacenters to provide service to the plurality of clients based on the determined costs of providing service and the capacity.

16. The cloud controller of claim 15, wherein determining a plurality of sets of candidate clients further comprises: calculating the remaining demand for at least one of the candidate clients.

17. The cloud controller of claim 16, wherein determining a plurality of sets of candidate clients further comprises:
calculating the cost of at least a portion of each data center providing capacity to a first candidate client;
selecting the data center with the lowest calculated cost; and
placing the selected data center in a set of candidate data centers for the first candidate client.

18. The cloud controller of claim 15, wherein determining a cost of providing service and a capacity capability for each of at least a portion of the select plurality of data centers further comprises:
initializing the cost of providing service for each of at least a portion of the select data centers;
determining the demand available at each of at least a portion of the select data centers for a first client; and
calculating the cost of providing service by each of at least a portion of the select data centers based upon the determined available demand at each of at least a portion of the select data centers and a cost of transporting demand between the data centers and the first client.

19. The cloud controller of claim 18, wherein initializing the cost of providing service for each of at least a portion of the select data centers further comprises:
determining that a first data center has remaining capacity and setting a first capacity to the remaining capacity; and
setting a cost of providing service by the first data center to 0.

20. The cloud controller of claim 18, wherein initializing the cost of providing service for each of at least a portion of the select data centers further comprises:
determining that a first data center has no remaining capacity and setting a first capacity to a capacity of an additional virtual machine; and
setting a cost of providing service by the first data center to the cost of an additional virtual machine.
